(19) United States
(12) Patent Application Publication
(10) Pub. No.: US 2026/0327827 A1
(43) Pub. Date: Oct. 22, 2026

(54) GAS PRESSURE BALANCE METHOD IN AN ELECTROLYSER SYSTEM AND ELECTROLYSER SYSTEM WITH A PRESSURE BALANCE VALVE SYSTEM

(71) Applicant: thyssenkrupp nucera AG & Co. KGaA, Dortmund (DE)

(72) Inventor: Henrik GØBEL FÜCHTBAUER, Kolding (DK)

(73) Assignee: thyssenkrupp nucera AG & Co. KGaA, Dortmund (DE)

(21) Appl. No.: 19/473,406

(22) PCT Filed: Feb. 22, 2024
(86) PCT No.: PCT/EP2024/054473

§ 371 Date: Oct. 7, 2025

(30) Foreign Application Priority Data
Feb. 22, 2023 (DK) PA202300159

(51) Int. Cl. C25B 15/02; C25B 1/04; C25B 15/08

(52) U.S. Cl. CPC C25B 15/02; C25B 15/08; C25B 1/04

(57) ABSTRACT

In a gas pressure balance method in an electrolyser system a predefined pressure difference between pressures in an oxygen gas separation tank and a hydrogen gas separation tank is maintained by controlled release of gases through an oxygen back pressure valve and a hydrogen back pressure valve. in a first step, for each of the oxygen back pressure valves and the hydrogen back pressure valves, a predefined, calibrated pilot gas pressure is generated and in a second step, the predefined, calibrated pilot gas pressures are forwarded to the respective back pressure valves and in a third step, hydrogen and oxygen gasses are released whenever the gas pressures in the hydrogen and oxygen separation tanks exceeds the predefined, calibrated pilot pressure in the respective pilot gas streams.

The present invention relates to a gas pressure balance method in an electrolyser system. The invention further relates to an electrolyser system with a pressure balance valve system.

### BACKGROUND OF THE INVENTION

In electrolyser systems, such as in pressurised alkaline water electrolysers having a cell stack and product separation tanks for product depletion of electrolytes drawn from the cell stacks, it is a well-known problem that maintaining a pressure balance in the hydrogen and oxygen gas separation tanks is a challenging task. According to the invention, an improved- or at least alternative method and system-is provided to ensure a predefined pressure balance in the two product tanks. In the following description, the gases released by electrolysis of water, namely hydrogen and oxygen, are referred to as product gases. Initially the gases are more or less embedded in lye streams gleaned off the electrolyser stacks, but the gases are released from the lye in the gas/lye separator tanks.

### SUMMARY OF THE INVENTION

According to a first aspect, the objects of the invention may be obtained by a gas pressure balance method in an electrolyser system, whereby a predefined pressure difference between pressures in an oxygen gas separation tank and a hydrogen gas separation tank, with the tanks being connected to each their output side of a water electrolyser stack or multitude of stacks, is maintained by controlled release of gases through an oxygen back pressure valve and a hydrogen back pressure valve arranged in fluid connection with the respective separation tank.

According to this aspect of the invention, in a first step, for each of the oxygen back pressure valves and the hydrogen back pressure valves, a predefined, calibrated pilot gas pressure is generated by a feed and bleed valve system in a pilot gas stream and in a second step, the predefined, calibrated pilot gas pressures are forwarded to the respective back pressure valves and in a third step, hydrogen is released from the hydrogen gas separation tank through the hydrogen back pressure valve whenever the gas pressure in the hydrogen separation tank exceeds the predefined, calibrated pilot pressure in the first pilot gas stream, and oxygen is released from the oxygen gas separation tank through the oxygen back pressure valve whenever the gas pressure in the oxygen gas separation tank exceeds the predefined, calibrated pilot pressure in the second pilot gas stream.

With this method and system, a very agile and precise regulation of the pressures in the two separation tanks is provided, and a precise pressure difference between the tanks, possibly a zero-pressure difference, may be maintained. Also, quick adaptations to demands of a change in pressure difference will be possible. This is mainly due to the fact that very little mass needs to be moved or accelerated in order to change the setting of the gas release valves when they are guided by a pilot gas pressure. This works particularly well when a dome loaded valve is employed as the gas release valve as for this setup, the pilot gas and the membrane are all that need to budge in order to change the setting of the valve, and both of these work with very little friction and comprise a minimum of masses.

In a further embodiment, the feed and bleed valve system comprises a bleed valve which bleeds off a pilot gas through a bleed orifice to ambient pressure or similarly low pressure, and where the feed and bleed valve system further feeds pilot gas to the bleed valve through an adjustable feed valve, such that pilot gas at the desired pressure is achieved between the bleed valve and the feed valve by adjusting the feed valve opening degree.

This arrangement ensures a precise pilot gas pressure, and keeps the reaction time very low, so that there is a very small time lag from the occurrence of a new input value, such as a pressure value signal from measurements of pressure or pressure difference in one or both separation tank or tanks, until the correction in pilot gas pressure is provided between the feed and the bleed valve.

In an embodiment, the first pilot gas stream and the second pilot gas stream are generated by supplying a pressurised pilot gas to a gas pump, and a pressurised booster gas is supplied such as pressurised atmospheric air to a motor whereby the motor drives the gas pump and thereby increases the pressure of the pressurised pilot gas stream, and where further, the pilot gas stream is branched into a first pilot gas stream and second pilot gas stream both having pressures well above the pressures needed to close off back pressure valves for the hydrogen and the oxygen gas separation tanks.

The pressure needed in the pilot gas stream in order to close off a product gas must, by the nature of the oxygen and hydrogen back pressure valves, be higher than the pressures in the respective separation tanks. This high pressure may be generated in a local booster pump, which picks up a pilot gas at a predefined delivery pressure and pressurises it further to the needed pilot gas operation pressure. This may be beneficial in cases where pressure levels not usually available in industrial gases is needed to control the back pressure valves. It is preferred to have the booster pump driven by pressurised air, which is readily available. If an inert or partially inert gas such as nitrogen gas is used as the pilot gas, only one booster pump is needed, and the thereby sufficiently pressurised pilot gas may be branched off to reach each of the two different feed and bleed valve arrangements.

In a further embodiment of the method, the first pilot gas stream is derived from the oxygen pipe and the second pilot gas stream is derived from the hydrogen pipe and furthermore, the two pilot gas streams are boosted by way of each their product gas pump whereby the pumps are driven by motors powered by a source of pressurised atmospheric air.

This embodiment allows for the respective product gases to be used as the respective pilot gases, which is highly desirable, as it ensures, that hydrogen is used as pilot gas in a dome loaded hydrogen back pressure valve and oxygen is used as the pilot gas in a dome loaded oxygen back pressure valve. In this way, an increased security against possible mixtures of the oxygen and the hydrogen gases is provided, and a use of a third gas such as nitrogen is omitted. The two product gas booster pumps are preferably driven by a motor powered by pressurised atmospheric air.

In a further embodiment of the method, the gas stream which is continually leaked from the bleed valves of the feed and bleed valve systems are piped to each their gas quality control measurement device and furthermore, a supplement product gas supply valve is arranged in a supplement gas pipe between each of the product gas pipes and the respective gas quality control measurement device whereby this supplement product gas supply valve is guided by a signal derived from a fluid flow measurement device arranged between the bleed valve and the respective gas recipients.

This embodiment ensures, that the gases which escape the bleed valves are used in a gas quality meter. The gas quality meter is a safety requirement and thus a gas stream necessarily must be provided for this purpose, and in case the product gases are used as pilot gas, the bleed off from the bleed valve may as well be used for this purpose too. In order for the gas quality meters to also work when the gas stream is low or pressures are low, a supplemental product gas is provided circumventing the feed and bleed valve system.

In a second aspect, the objects of the invention may be obtained by an electrolyser system, which has a pressure balance valve system, whereby an oxygen separation tank and a hydrogen separation tank are provided with each their pipe connection to respective sides of separation diaphragms in one or more electrolyser stacks, and an oxygen back pressure valve and a hydrogen back pressure valve, coupled to the respective separation tanks through piping, are provided and adapted to open for controlled release of oxygen and hydrogen product gases at predefined product gas separation tank pressures.

According to this aspect of the invention, the back pressure valves are adapted to open for release of product gas against a predefined pilot gas pressure, and further the feed and bleed valve system generates the predefined pressure from high pressure gas in a pipe interconnecting a feed valve and a bleed valve where the bleed valve is adapted to deliver a bleed off of pilot gas to low pressure, and the feed valve is adapted to be regulated to deliver pilot gas into the pipe interconnecting the feed valve and bleed valve such that the desired predefined pressure is maintained in the pipe between the feed valve and the bleed valve.

The feed valve may preferably be regulated by a PLC setpoint generator, where the setpoint generator amongst others, receives signals indicative of the pressure in the gas separation tank to be regulated, and/or receives a measure of the pressure difference between the two separation tanks as well as the actual pressure in the pipe between the bleed valve and the feed valve, and regularly calculates a revised setting for the opening degree of the feed valve. Agile and expedient generation of the calibrated pilot gas pressure in the pipe between the feed and the bleed valve is assured in this way.

The electrolyser system further comprises a pilot gas source which is connected to a gas pump, where the pump is adapted to act as a booster to further pressurise the pilot gas stream, whereby the pilot gas pump is adapted to be driven by a motor which is adapted to receive its driving energy from a source of pressurised atmospheric air.

If a local pilot gas source is used such as pressurised nitrogen, a boost of the pressure of the nitrogen may be needed. With the nature of the electrolyser plant, with oxygen and hydrogen gases under pressure, it is preferred to use a method of compression, which leaves out the risk of electric sparks, electric heating and similar issues and rely on the less hazardous driver of pressurised atmospheric air. Also, the stream of decompressed atmospheric air, which necessarily must exit such a motor, may be used to ensure air renewal in parts of the plant, where air exchange rates are mandatory. Preferably, the motor is supplied with a driver gas stream having a lower pressure than the pressure in the high-pressure pilot gas stream delivered by the pump.

In an embodiment of the invention, the first pilot gas stream originates from the oxygen pipe and is connected to the feed and bleed valve system through a gas booster pump and the second pilot gas stream originates from the hydrogen pipe and is connected to the feed and bleed valve system through a further gas booster pump such that the feed and bleed valve arrangements are provided with product gas for the first and second pilot gas streams.

Using the product gas streams directly as the pilot gas to control the opening and closing of the hydrogen and oxygen release valves requires that the product gas pressure in the pilot gas stream be increased, and thus the pilot gas streams in this case are pressure boosted. Preferably, a compressed air driven pump is used for the boosting of the two pilot gas streams derived from each their product gas stream. When hydrogen is used to regulate the hydrogen back pressure valve, and oxygen is used to regulate the oxygen back pressure valve, there is no risk that hydrogen and oxygen gases are mixed.

In an embodiment of the invention, the back pressure valve is a dome loaded valve, where the pilot pressure is provided on the one side of a membrane, where the product gas side of the membrane is adapted to abut two sets of orifices: a first set of orifices, which are in fluid communication with the mentioned product separation tank, and a second set of orifices which are in communication with a recipient for the respective product gas.

When the membrane abuts the two sets of orifices, product gas is prevented from moving through the valve, and when the membrane is elevated due to higher pressure on the product gas side thereof, the valve is open, and gas will pass from the first set of orifices to the second set of orifices. The valve may well be made with orifices placed in concentric circles with inlet orifices placed in a first half-circle and outlet orifices in an opposed second half of the same circle. This placement allows for a gradual opening and closing action of the valve, and this ensures, that regulation characteristics are the same regardless of the opening degree.

In an embodiment, in a gas exit pipe between the bleed valve and a product gas recipient, a gas quality control measurement device is arranged and furthermore, a supplement product gas supply valve is arranged in a supplement gas pipe between each of the product gas pipes and the respective gas quality control measurement device whereby this supplement product gas supply valve is arranged to be guided by a signal derived from a fluid flow measurement device arranged between the bleed valve and the respective gas recipients at a far end of a gas exit pipe.

The supplement gas pipe ensures that even when the flow through the bleed valve is too low to ensure a reliable gas quality measurement, reliable data are obtained. During steady state production the supplement product gas supply valve is closed, and the gas flowing out of the bleed valve will be sufficient.

In the context of the present invention, the gases released by electrolysis of water, namely hydrogen and oxygen, are referred to as product gases.

It should be emphasized that the term “comprises/comprising/comprised of” when used in this specification is taken to specify the presence of stated features, integers, steps or components but does not preclude the presence or addition of one or more other features, integers, steps, components or groups thereof.

### BRIEF DESCRIPTION OF THE DRAWINGS

In the following, the invention will be described in greater detail with reference to embodiments shown by the enclosed figures. It should be emphasized that the embodiments shown are used for example purposes only and should not be used to limit the scope of the invention.

FIG. 1 is a schematic representation of a system according to the invention,

FIG. 2 shows a schematic representation of a further system according to the invention,

FIG. 3 discloses a schematic representation of a system wherein oxygen pressure is lead,

FIG. 4 shows a gas back pressure valve,

FIG. 5 is a schematic view of a pilot gas pressure regulation valve of the dome loaded kind with an accompanying feed and bleed valve system,

FIG. 6 shows a schematic representation of the re-use of the excess gases from the bleed valve in a gas quality surveillance device, and

FIG. 7 is a schematic representation of a system including product gas booster pumps 47A; 47B adapted to boost the pressure of the product gases to be used as pilot gas.

### DETAILED DESCRIPTION OF THE EMBODIMENTS

Various exemplifying and non-limiting embodiments both as to constructions and to methods of operation, together with additional objects and advantages thereof, will be best understood from the following description of specific exemplifying and non-limiting embodiments when read in conjunction with the accompanying drawings.

The verbs “to comprise” and “to include” are used in this document as open limitations that neither exclude nor require the existence of unrecited features. The features recited in dependent claims are mutually freely combinable unless otherwise explicitly stated. Furthermore, it is to be understood that the use of “a” or “an”, i.e. a singular form, throughout this document does not exclude a plurality.

### Electrolyser and Gas Release Valves

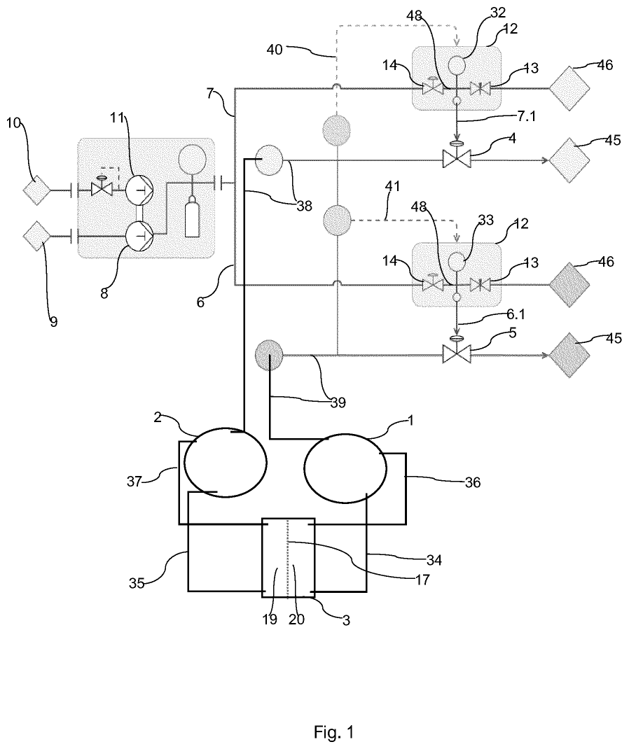

The system disclosed in FIG. 1 comprises a source such as a gas separation tank 1, 2 for each product gas from an electrolyser stack. Each source, gas separation tank 1, or gas separation tank 2, is indicated by a circle in the figures and comprises a gas/electrolyte separation tank 1, 2. The hydrogen gas separation tank 2 receives the catholyte and hydrogen (product) gas mixture from the first side 19 of separation diaphragms 17 of one or more stacks 3, via a catholyte and hydrogen gas line 37.

The oxygen separation tank 1 receives the anolyte and oxygen gas (product) mixture from a second side 20 of the separation diaphragm or diaphragms 17 of the same stack 3 or stacks via an anolyte and oxygen gas line 36. Each of the oxygen and hydrogen separation tanks 1, 2 may receive gas/electrolyte mixtures from one or more electrolyser stacks 3. Usually, a stack 3 comprises a multitude of pairs of electrolytic chambers, each such pair being separated by a diaphragm 17, however for the sake of simplicity, the drawing only one such pair of chambers is illustrated in FIG. 1.

In the example given in FIG. 1, product depleted anolyte in an anolyte pump back line 34 and product depleted catholyte in a catholyte pump back line 35 reach each their respective side of the diaphragm or diaphragms 17 to completely separate anolyte and catholyte flow circuits.

In other electrolyser systems for the generation of hydrogen from water, the anolyte and catholyte flows are mixed prior to the introduction of the electrolyte in the cathodic and anodic chambers of the stack.

Pumps and heat exchangers in the return pipes to the stacks are not shown in FIG. 1 but may well be provided to enhance fluid flow and ensure temperature adjustment of the fluids to be introduced into the stack.

The pressure in the two tanks 1, 2 should be maintained in balance to ensure that the pressures at each side of the diaphragm 17 in the stack 3 are alike and do not deviate from each other beyond predefined limits. This is obtained by a controlled release of product gases namely oxygen and hydrogen through controlled back pressure valves 4, 5 arranged in gas pipes adapted to pipe the produced gases to recipients 45, 46 thereof. A hydrogen pipe 38 ensures passage from the hydrogen gas separation tank 2 and the hydrogen back pressure valve 4, and an oxygen pipe 39 ensures passage from the oxygen gas separation tank 1 and the oxygen back pressure valve 5.

Each of the back pressure valves 4, 5 is controlled by a dedicated pilot gas having each its pilot gas pressure.

### Dome Loaded Valve

In one embodiment, the back pressure valve 4, 5 is a dome loaded valve 22, where the pilot pressure is provided on the closing pressure side 16 of a membrane 23, where the product gas side 18 of the membrane 23 is adapted to abut two sets of orifices: a first set of orifices 24, which are in fluid communication with the mentioned product separation tank, and a second set of orifices 25 which are in communication with a recipient (not shown) for the respective product gas.

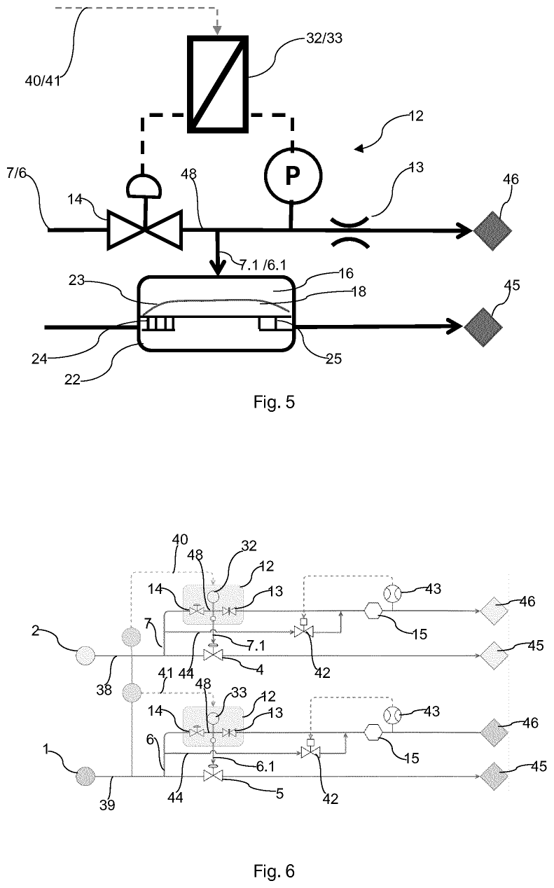

When the pressure on the closing pressure side 16 of the membrane is higher than the pressure on the product gas side 18, the two sets of orifices are closed as the membrane 23 is pressured towards the orifices 24, 25 and vice versa: when the pilot pressure is lower than the product pressure, the membrane 23 is lifted off the two sets of orifices 24, 25 as seen in FIG. 5, and gas shall pass through the valve 22 from the respective connected gas separation tanks 1, 2 to the recipient (not shown).

The dome loaded valve 22 is very agile as both internal friction and moved masses during opening or closing are minimal. Also, this type of valve tends to maintain unchanged dynamic characteristics throughout its opening range.

### Piston Valve With Area Exchange

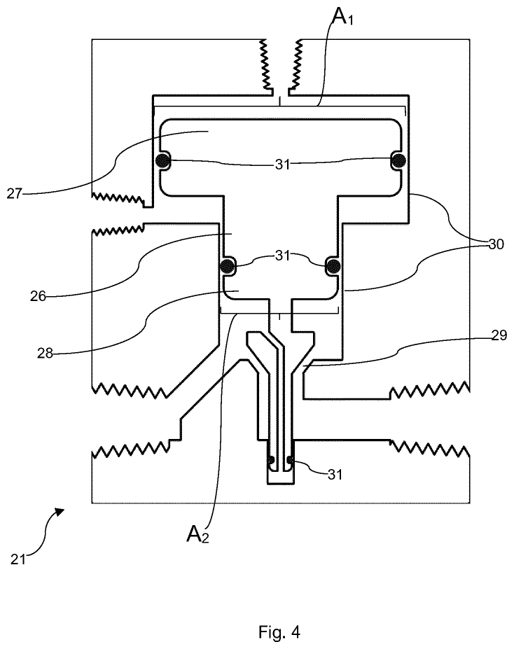

In a further form, the back pressure valve 4, 5 as schematically shown in FIG. 4, is a piston valve member 21. The valve member 21 has a piston 26 which at a first end 27 has a first gas pressure impact area A₁ for moving the piston 26 in a first direction, and at a second end 28 has another (second) gas pressure impact area A₂ for moving the piston in a second, opposed direction.

In the design of the valve disclosed in FIG. 4, the first gas pressure impact area A₁ is adapted to be in fluid communication with the pilot gas, and the second gas impact area A₂ is adapted to be charged with the product gas at its product gas pressure. When the product gas pressure increases to a level where this pressure is able to move the piston in the second direction (upwards in FIG. 4), an opening 29 will be provided for the product gas to escape there through to reach an outlet. The outlet shall be connected to a recipient (not shown) for the product gas. The pressure in the pilot gas maintains the valve in a closed position whenever the quotient product gas pressure/pilot gas pressure is bigger than the A1/A2 quotient.

A difference in the A₁ and A₂ areas allows for the valve to close even if the pilot gas pressure is below the product gas pressure.

In an embodiment, and as shown in FIG. 4, the piston 26 is adapted to move in a cylinder 30 and comprises piston rings or O-rings 31 or the like gasketing between piston 26 and cylinder 30 at both the A₁ and A₂ ends of the piston 26.

Other kinds of pistons, such as bellows sealed pistons and cylinder pairs may be used for reduced friction and inertia and increase agility of the valve 21.

The piston 26 may be made from a lightweight material such as a polymer, and/or may be hollow to ensure that the moved mass remains as small as possible to ensure good closing and opening characteristics of the valve.

### Gas Pressure Balance Method

As seen in FIGS. 1, 2 and 3 a feed and bleed valve system 12 is arranged to deliver a predefined pilot gas pressure to control the opening pressure of either a dome loaded valve 22 or a piston valve member 21.

If a dome loaded valve 22 is used, the pilot gas pressure needs to be higher than the pressure in the product gas in order to move the membrane 23 towards the two sets of orifices 24, 25. To produce the necessary pressure in the first and second pilot gas streams, the pilot gas streams are produced by boosting the pressure of a pre-pressurised nitrogen gas stream 9.

As shown in FIG. 1, this is done by feeding the pre-pressurised nitrogen gas stream 9 through a gas pump 8, which is driven by a motor 11, such that the nitrogen gas stream 9 leaves the pump at a higher pressure than its entering pressure.

In the embodiment in FIG. 1, the motor 11 is driven by a stream of compressed air 10. A gearing or other mechanical exchange between the compressed air driven motor 11 and the gas pump allows for the pump 8 to deliver the pilot nitrogen gas at a pressure well above the highest pressure of any of the product gases.

### Any Inert Gas or Gas Composition Other Than Nitrogen May Be Used As Pilot Gas.

As seen in FIG. 1, the boosted pressurised nitrogen gas is split into a first pilot gas stream 6 and a second pilot gas stream 7.

### PLC Setpoint Generation

Feed and bleed valve systems 12 are arranged to downsize the pilot gas stream 6, 7 pressures according to a PLC generated setpoint for controlled release of product gases 38, 39.

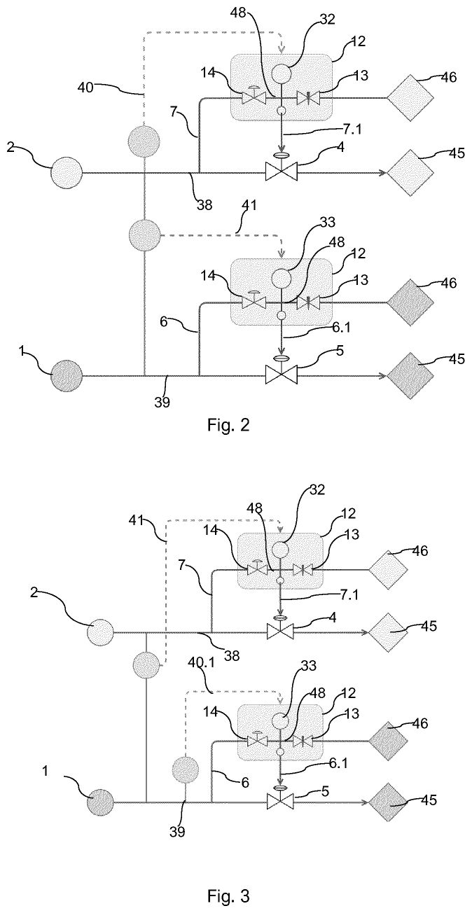

The setpoints for the hydrogen and oxygen back pressure valves 4, 5 are derived from a pressure or pressure difference signals 40, 41 originating from pressure measurement in the product gas streams 38, 39 as seen in FIG. 1 and FIG. 2. The setpoint is determined under the guidance of a PLC release pressure setpoint generator 32, 33.

PLC setpoint generators 32, 33 are programmable devices, which will be able to take into account a range of parameters, such as time constants of the system, electric power provided to the electrolysers, signals derived from time dependent pressure changes of the measured input pressure signals and the like, especially differential and integration signals In FIG. 5, the setpoint generator 32, 33 controls the opening degree of the pilot gas feed valve 14 based on the calculated setpoint and the pressure P between the feed valve 14 and the bleed valve 13. The setpoint may be calculated from the pressure in the gas separation tank from which product gas is to be released, in which case, the pressure in the other gas separation tank shall be guided by the differential pressure between the two tanks. This is illustrated in FIG. 1 and FIG. 2. In FIG. 2 as well as in FIG. 1, the gas pressure signal 40 from the pressure in the hydrogen pipe 38, which is also a measure of the pressure in the hydrogen release tank 2, is served at the PLC hydrogen release pressure setpoint generator, which then calculates the setpoint for the feed valve 14. Furthermore, the pressure difference signal 41 is served at the PLC oxygen release pressure setpoint generator 33, in order for the setpoint generator 33 to calculate a setpoint for the feed valve 14 to control the release of oxygen through the oxygen back pressure valve 5. In this way, the pressure in the oxygen pipe 39 which again is a measure of the pressure in the oxygen gas separation tank 1 may be guided to follow or deviate in a predetermined manner from the pressure in the hydrogen gas separation tank.

In FIG. 3, a similar system is shown, however here the pressure in the oxygen tank 1 via pressure signal 40.1 from the pipe 39 is used to direct the release of oxygen, while the differential pressure signal 41 between the pressure in the hydrogen and the oxygen separation tanks guides the release of the hydrogen.

Feed and bleed valve system The setpoints from the PLC devices are used in the feed and bleed valve systems 12 to regulate the setting of the feed valves 14 seen in FIGS. 1, 2, 3, and 6.

Increased pilot gas feed through the feed valve 14 into pipe 48 will thereby cause an increase in the calibrated pressure 6.1, 7.1 delivered out of the feed and bleed valve system 12 to back pressure valves 4, 5.

By monitoring the pressure in the pipe 48 between the feed valve 14 and the bleed valve as indicated in FIG. 5 by pressure monitor P, the difference between a setpoint which has been calculated in PLC 32 or 33 and the present measured calibrated pressure may be determined, and a corresponding regulation action signal forwarded to the regulated feed valve 14.

The shown bleed valve 13 may be a regulatable or an un-regulatable valve. If valve 13 is a regulatable valve, the bleed flow may be increased or decreased according to need. In case the need for regulation of the setting of back pressure valves 4, 5 is very limited, such as in a hot stand by situation, very little bleed of gases is required to maintain a setting of the back pressure valves 4, 5 and followingly the bleed rate can be maintained very small. In other kinds of settings, where fast opening or closing action of the back pressure valves is required, a higher bleed rate is beneficial, as it allows for faster pressure drops in the pipe segments 7.1, 6.1 between the feed and bleed valves.

### Pilot Gas Regulated Back Pressure Piston Valve

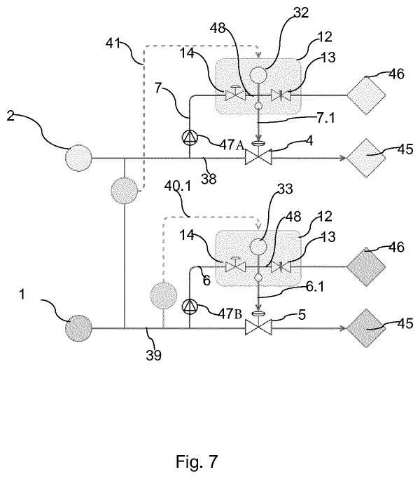

In the FIG. 2, FIG. 3, FIG. 6, and FIG. 7 embodiments, the pilot gas for the hydrogen release valve 4 is hydrogen derived from the hydrogen separation tank, and the pilot gas for the oxygen release valve 5 is the oxygen derived from the oxygen separation tank. In these cases, it will be necessary to either boost the pilot gas pressures to be able to feed pilot gas through the feed and bleed valve system 12 and provoke a calibrated output pilot gas pressure, which is sufficient for the closing of a dome loaded valve 22, or alternatively use a back pressure valve 4, 5 which will close at a lower pilot gas pressure than the back pressure in the pipes 38, 39 respectively.

In case boost of the pilot gas, which is now also production gas, is used, pressurised atmospheric air may be used in a set of motors, which drives each of a hydrogen product gas booster pump 47A and an oxygen product gas booster pump 47B, operating on gas supplied from the gas separation tanks to control each of the dome loaded valves. This is indicated in FIG. 7. In this way the valve controlling the outflow of hydrogen is loaded with hydrogen for the control of the membrane 23, and followingly the valve controlling the outflow of oxygen is loaded with oxygen for the control of the membrane 23. Improved security is achieved in that the risk of oxygen and hydrogen mixing is minimised.

It is also possible to introduce a pressure drop in the oxygen and hydrogen pipes 38, 39 between the pilot gas branches 6, 7 and the back pressure regulators 4, 5 to thereby ensure that there is always a higher pressure in the branches 6, 7 than at the back pressure regulators 4, 5. This may however lead to lower output pressure at the recipients 45, which is un-desirable.

Alternatively, a back pressure regulated piston valve 21 as shown in FIG. 4 may be used, wherein a closing action area A₁ at a first end 27 of a back pressure valve piston 26, is charged with the pilot gas pressure, and is somewhat larger than the opening action area A₂ of a second end 28 of the back pressure valve piston 26, which is charged with the pressure within the respective separation tank. The release valve piston 26 is adapted to regulate an opening 29 which closes off a product gas stream there through, whenever the in-equation:

A₂×product gas pressure<A₁×pilot gas pressure

is true.

As seen, A₁ is somewhat larger than A₂, and thus even when a calculated pressure loss through the feed and bleed valve system 12 for the generation of the right pilot gas pressure is accommodated, it will always be able to provide the needed pressure to close the valve 21 with the use of the product gas and un-boosted product gas pressure as the pilot gas and pilot pressure. This is indicated in FIG. 6, where there is no boost of the pilot gas streams 6, 7. It is preferred that

1.1×A₂≤A₁≤2×A₂

By ensuring the relation that A₁ is between 1.1 times bigger and no more than 2 times bigger than A₂, it will always be possible to close the valve, and a good precision is obtainable.

If a better precision and dynamic performance is desired, it is preferred that

1.05×A₂≤A₁≤1.2×A₂

By keeping A₁ even closer to the area of A₂ such as 1.05 times bigger than A₂ and no more than 1.2 times bigger than A₂, even better dynamic performance may be ensured.

In FIGS. 2 and 3, either boost of the pilot gas or a valve with the special back pressure valve piston 26 is used.

### Re-Use of Leaked Gases Through the Bleed Valve

A gas stream will continually be leaked from the bleed valves 13 of the feed and bleed valve systems 12 described above when regulating the back pressure valves. However, in the case where the product gas is used as the pilot gas, this leaked gas stream may be used in a gas quality control measurement device 15 for each of the two leaked gas streams. This is disclosed in FIG. 6. Hereby it is ensured, that the leaked gas is used to generate necessary information on the quality of the produced gases or used for the generation of safety data, such as the proportion of H₂ in the O₂ gas and the proportion of O₂ in the produced H₂ gas.

A minimum flow through the gas quality control measurement device 15 is required in order to gain reliable gas quality surveillance data, and thus a supplement product gas supply valve 42 is arranged in a supplement gas pipe 44 between the product gas pipes 38, 39 and the gas quality control measurement device 15. This valve is guided by a signal derived from the fluid flow measurement device 43, such that the product gas supply valve 42 will open whenever the flow measurement device 43 registers too low flow through the gas quality control measurement device 15.

### Hydrogen Control Signal Derived From Hydrogen Pipe Pressure

In FIG. 1, the pressure in the hydrogen pipe 38 will be the same as the pressure inside the hydrogen as the pressure in the separation tank 2 is used via a pressure signal 40 to regulate the hydrogen back pressure valve 4. In this embodiment, the difference pressure signal 41 (which is the pressure difference between pressures in the two separation tanks 2, 1) is used to guide the release of oxygen through the oxygen back pressure valve. In the embodiment the feed and bleed valve systems 12 receive pilot gas streams 6, 7 in the shape of nitrogen gas, which has been pressurised to a pressure well above the maximum pressures allowable for the product gas streams.

This nitrogen gas stream may well be supplanted by product gas streams which has been boosted or may be supplanted by product gas streams at the pressure in respective separation tanks 1, 2 in combination with a back pressure valve member 21 with two different gas acting areas A₁, A₂ as disclosed in FIG. 4 and described above.

It is to be noted that the figures and the above description have shown the example embodiments in a simple and schematic manner. Many of the specific mechanical details have not been shown since the person skilled in the art should be familiar with these details and they would just unnecessarily complicate this description.

### LIST OF PARTS

1 Oxygen gas separation tank
2 Hydrogen gas separation tank
3 Water electrolyser stack
4 Hydrogen back pressure valve
5 Oxygen back pressure valve
6 First pilot gas stream (O₂)
6.1 First calibrated pilot pressure
7 Second pilot gas stream (H₂)
7.1 Second calibrated pilot pressure
8 Gas booster pump
9 Pressurised nitrogen
10 Pressurised atmospheric air
11 Motor
12 Feed and bleed valve system
13 Bleed valve
14 Feed valve
15 Gas quality control measurement device
16 Closing pressure side of membrane
17 Diaphragm
18 Product gas side of membrane
19 First side of diaphragm or diaphragms
20 Second side of diaphragm or diaphragms
21 Piston valve member
22 Dome loaded valve
23 Membrane
24 First set of orifices
25 Second set of orifices
26 Back pressure valve piston
27 First end
28 Second end
29 Opening
30 Cylinder
31 Piston rings
32 PLC hydrogen release pressure setpoint generator
33 PLC oxygen release pressure setpoint generator
34 Anolyte pump back line
35 Catholyte pump back line
36 Anolyte and oxygen gas line
37 Catholyte and hydrogen gas line
38 Hydrogen pipe
39 Oxygen pipe
40 Pressure signal, hydrogen
40.1 Pressure signal, Oxygen
41 Pressure difference signal
42 Product gas supply valve
43 Fluid flow measurement device
44 Supplement product gas supply
45 Product gas recipient
46 Atmosphere recipient
47A Hydrogen product gas booster pump
47B Oxygen product gas booster pump
48 Tube interconnecting feed valve and bleed valve
A₁ first gas pressure impact area/closing action area
A₂ second gas pressure impact area/opening action area

1.-10. (canceled)

11. A gas pressure balance method in an electrolyser system, in which system an oxygen gas separation tank and a hydrogen gas separation tank are connected to each their output side of a water electrolyser stack or multitude of a water electrolyser stacks, and by which method a predefined pressure difference between a pressure in the oxygen gas separation tank and a pressure in the hydrogen gas separation tank is maintained by controlled release of gasses through an oxygen back pressure valve and a hydrogen back pressure valve arranged in fluid connection with the respective separation tank, the method comprising:
for each of the oxygen back pressure valve and the hydrogen back pressure valve, generating a predefined, calibrated pilot gas pressure by a feed and bleed valve system in a pilot gas stream;
forwarding pilot gases at the predefined, calibrated pilot gas pressures to the respective back pressure valves; and
releasing hydrogen from the hydrogen gas separation tank through the hydrogen back pressure valve whenever the gas pressure in the hydrogen separation tank exceeds the predefined, calibrated pilot gas pressure, and
releasing oxygen from the oxygen gas separation tank through the oxygen back pressure valve whenever the gas pressure in the oxygen gas separation tank exceeds the predefined, calibrated pilot gas pressure.

12. The gas pressure balance method according to claim 11, wherein the feed and bleed valve system comprises a bleed valve which ambient pressure or similarly low pressure, and whereby the feed and bleed valve system further feeds pilot gas to the bleed valve through an adjustable feed valve, whereby pilot gas at the desired calibrated pressure is achieved in a tube between the bleed valve and the feed valve by adjusting the feed valve opening degree.

13. The gas pressure balance method according to claim 11, wherein the two pilot gas streams are generated by supplying a pressurised pilot gas to a gas pump, and supplying a pressurised booster gas such as pressurised atmospheric air to a motor and driving the gas pump by the motor and thereby increasing the pressure of the pressurised pilot gas stream, and branch the thereby further pressurised pilot gas into a first pilot gas stream and second pilot gas stream both having pressures well above the pressures needed to close off the back pressure valves of the hydrogen and the oxygen gas separation tanks.

14. The gas pressure balance method according to claim 11, wherein the first pilot gas stream is derived from an oxygen pipe and the second pilot gas stream is derived from a hydrogen pipe and that the two pilot gas streams are boosted by way of each their product gas booster pump whereby the pumps are driven by motors powered by a source of pressurised atmospheric air.

15. The gas pressure balance method according to claim 14, wherein a gas stream leaked from the bleed valves of the feed and bleed valve systems are piped to each their gas quality control measurement device and that further a regulatable supplement product gas supply valve is arranged in a supplement gas pipe between each of the product gas pipes and the respective gas quality control measurement device whereby this regulatable supplement product gas supply valve is guided by a signal derived from a fluid flow measurement device arranged between the bleed valve and the respective gas recipients.

16. An electrolyser system comprising:
a pressure balance valve system;
wherein an oxygen separation tank and a hydrogen separation tank are provided with each their pipe connection to respective sides of separation diaphragms in each of one or more electrolyser stacks;
wherein an oxygen back pressure valve is coupled to the oxygen separation tank, and configured to open for controlled release of oxygen product gasses at a predefined oxygen product gas separation tank pressure;
wherein a hydrogen back pressure valve is coupled to the hydrogen separation tank, and configured to open for controlled release of hydrogen product gasses at a predefined hydrogen product gas separation tank pressure;
wherein, the back pressure valves are configured to open for release of product gas against a predefined calibrated pilot gas pressure;
wherein a feed and bleed valve system generates the predefined calibrated pilot gas pressure in a pilot gas in a tube interconnecting a feed valve and a bleed valve;
wherein the bleed valve is configured to deliver a bleed off of pilot gas from the tube;
wherein the feed valve is configured to be regulated to deliver the desired predefined calibrated pressure of pilot gas in the tube.

17. The electrolyser system according to claim 16, wherein the first pilot gas stream originates from an oxygen product gas pipe and is connected to the feed and bleed valve system through a product gas booster pump, and the second pilot gas stream originates from a hydrogen product gas pipe and is connected to the feed and bleed valve system through a further product gas booster pump, such that the feed and bleed valve arrangements are provided with product gas for the first and second pilot gas streams.

18. The electrolyser system according to claim 16, wherein a pilot gas source is connected to a gas pump, which is configured to act as a booster and to further pressurise the pilot gas stream, and wherein the pilot gas pump is adapted to be driven by a motor, which is configured to receive its driving energy from a source of pressurised air.

19. The electrolyser system according to claim 17, wherein the back pressure valve is a dome loaded valve, where the pilot pressure is provided on a far side of a dome membrane, where the near side of the dome membrane is adapted to abut two sets of orifices: a first set of orifices, which are in fluid communication with the mentioned product separation tank, and a second set of orifices which are in communication with a recipient for the respective product gas.

20. The electrolyser system according to claim 17, wherein, in a gas exit pipe between the bleed valve and a recipient, a gas quality control measurement device is arranged, and
wherein a supplement product gas supply valve is arranged in a supplement gas pipe between each of the product gas pipes and the respective gas quality control measurement device, whereby this supplement product gas supply valve is arranged to be guided by a signal derived from a fluid flow measurement device arranged between the bleed valve and respective gas recipients.
